(19) United States
(12) Patent Application Publication
(10) Pub. No.: US 2008/0246907 A1
(43) Pub. Date: Oct. 9, 2008

(54) METHOD FOR PROVIDING IMPROVED DISPLAYING EFFECT OF LIQUID CRYSTAL PANEL IN OPERATION TEMPERATURE RANGE THEREOF

(75) Inventors: Ching-Huang Chen, Taipei (TW); Yung-Chih Lin, Taipei (TW); Mei-Fen Huang, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: ARIMA DISPLAY CORPORATION, Taipei (TW)

(21) Appl. No.: 11/696,236

(22) Filed: Apr. 4, 2007

(51) Int. Cl. G02F 1/1337

(52) U.S. Cl. 349/128

(57) ABSTRACT

A method for providing an improved displaying effect of a liquid crystal panel is provided, wherein the liquid crystal panel comprises two alignment layers disposing therebetween a liquid crystal layer having a spiral pitch and a liquid crystal twist angle. The method comprises steps of (a) spacing the two alignment layers at an interval with a desired twist angle therebetween; (b) measuring a first ratio of the interval to the spiral pitch of the liquid crystal layer, at which the liquid crystal twist angle is less than the desired twist angle between the two alignment layers; and (C) deciding an initial ratio of the interval to the spiral pitch of the liquid crystal layer being larger than the first ratio for providing the improved displaying effect of the liquid crystal.

### FIELD OF THE INVENTION

The present invention relates to a method for providing an improved displaying effect of the liquid crystal panel. More particularly, the present invention relates to a method for providing an improved displaying effect of the liquid crystal panel in an operation temperature range thereof.

### BACKGROUND OF THE INVENTION

Currently, the liquid crystal panel has been dominantly adopted to family electronic devices and digitalized offices for information displaying for various kinds of applications thereto, such as PCs, word processors, electronic packetbooks, packet TV sets, watches, home electric products, and portable notebooks.

The liquid crystal panel generally classified into two different operation principles respectively on the basis of the twisted nematic type and super twisted nematic type is mainly constituted by the polarizer, the ITO glass, the alignment layers and the liquid crystal layer. In respect of the operation principle of the twisted nematic type, the liquid crystal operates with a suitable chiral substance, so that the arranged liquid crystal molecules could bear chiral properties for polarizing the light through a rotation of 90 degrees. Furthermore, in respect of the operation principle of the super twisted nematic type, the liquid crystal molecules bear the spiral twist of 180-240 degrees and feature the rapid transformation of the configuration thereof concerning the photoelectric interchange characteristics.

It is recognized that the liquid crystal panel of the super twisted nematic type would result in a deficient displaying effect as a black shadow in a normal temperature of 25° C. due to inappropriate alignment between the liquid crystal molecules and the alignment layers or the abrasion process for the alignment layers. Furthermore, the deficient displaying effect as a black shadow in high temperature is generally overcome by replacing the original liquid crystal layer for one with a higher nematic-isotropic transition temperature, which takes additional cost therefor.

In order to overcome the drawbacks in the prior art, a method for providing an improved displaying effect of a liquid crystal panel in an operation temperature range thereof is proposed through arduous experiments and research.

### SUMMARY OF THE INVENTION

It is a first aspect of the present invention to provide a method for providing an improved displaying effect of a liquid crystal panel.

It is a second aspect of the present invention to provide a method for providing an improved displaying effect of a liquid crystal panel in an operation temperature thereof.

It is a third aspect of the present invention to provide a method for providing an improved displaying effect of a liquid crystal panel, wherein the liquid crystal panel comprises two alignment layers disposing therebetween a liquid crystal layer having a spiral pitch and a liquid crystal twist angle. The method comprises steps of (a) spacing the two alignment layers at an interval with a desired twist angle therebetween; (b) measuring a first ratio of the interval to the spiral pitch of the liquid crystal layer, at which the liquid crystal twist angle is less than the desired twist angle between the two alignment layers; and (C) deciding an initial ratio of the interval to the spiral pitch of the liquid crystal layer being larger than the first ratio for providing the improved displaying effect of the liquid crystal.

Preferably, the first ratio corresponds to a maximal ratio which implies that the liquid crystal twist angle of the liquid crystal layer is less than the desired twist angle between the two alignment layers.

Preferably, the method further comprises a step of adjusting the initial ratio in accordance with an operation voltage parameter of the liquid crystal panel.

Preferably, the method further comprises a step of adjusting the initial ratio in accordance with a response time parameter of the liquid crystal panel.

Preferably, the method further comprises a step of adjusting the initial ratio in accordance with a contrast parameter of the liquid crystal panel.

Preferably, the initial ratio is varied in an operation temperature range being ranged from 25° C. to 100° C. and remains larger than the first ratio.

It is a fourth aspect of the present invention to provide a method for providing an improved displaying effect of a liquid crystal panel in an operation temperature range thereof, wherein the liquid crystal panel comprises two alignment layers disposing therebetween a liquid crystal layer having a spiral pitch and a liquid crystal twist angle. The method comprises steps of (a) spacing the two alignment layers at an interval with a desired twist angle therebetween; (b) measuring a first ratio of the interval to the spiral pitch, wherein the first ratio implies that the liquid crystal twist angle is less than the desired twist angle between the two alignment layers; (c) measuring a second ratio of the interval to the spiral pitch, wherein the second ratio implies that the liquid crystal twist angle of the liquid crystal layer is larger than the desired twist angle between the two alignment layers; and (d) deciding an initial ratio of the interval to the spiral pitch, wherein the initial ratio varies in the operation temperature range and maintains larger than the first ratio and less than the second ratio for providing the improved displaying effect of the liquid crystal panel in the operation temperature range.

Preferably, the first ratio corresponds to a maximal value which implies that the liquid crystal twist angle is less than the desired twist angle between the two alignment layers.

Preferably, the second ratio corresponds to a minimal value which implies that the liquid crystal twist angle of the liquid crystal layer is larger than the desired twist angle between the two alignment layers.

Preferably, the liquid crystal panel is a color super twisted nematic liquid crystal panel.

Preferably, the method further comprises a step of adjusting the initial ratio in accordance with an operation voltage parameter of the liquid crystal panel.

Preferably, the method further comprises a step of adjusting the initial ratio in accordance with a response time parameter of the liquid crystal panel.

Preferably, the method further comprises a step of adjusting the initial ratio in accordance with a contrast parameter of the liquid crystal panel.

Preferably, the operation temperature is ranged is from 25° C. to 00° C.

It is a fifth aspect of the present invention to provide a liquid crystal panel with an improved displaying effect in operation. The liquid crystal panel comprises two alignment layers spaced at an interval with a desired twisted angle therebetween, and a liquid crystal layer disposed between the two alignment layers and having a spiral pitch, a liquid crystal twist angle and an initial ratio of the interval to the spiral pitch. The initial ratio is varied and maintains the liquid crystal twist angle being consistent with the desired twist angle for providing the improved displaying effect of the liquid crystal panel.

Preferably, the liquid crystal panel is one of a mono super twisted nematic liquid crystal panel and a color super twisted nematic liquid crystal panel.

Preferably, the operation is performed in a temperature being ranged from 25° C. to 100° C., and the initial ratio is varied in the temperature.

Preferably, the liquid crystal layer includes one of an S-811 and a chiral dopant with its spiral pitch varying with a temperature.

Preferably, the desired twisted angle is a super twisted angle.

Preferably, the desired twisted angle is an angle of 240 degrees.

Other objects, advantages and efficacies of the present invention will be described in detail below taken from the preferred embodiments with reference to the accompanying drawings, in which:

### BRIEF DESCRIPTION OF THE DRAWINGS

FIG. 1 is a diagram showing the relationship between the liquid crystal molecular spiral pitch and the temperature of the method for providing the improved displaying effect of the liquid crystal panel in the operation temperature range thereof according to a first preferred embodiment of the present invention;

FIG. 2 is an implementing step diagram showing the method for providing the improved displaying effect of the liquid crystal panel in the operation temperature range thereof according to a second preferred embodiment of the present invention; and

FIG. 3 is an implementing step diagram showing the method for providing the improved displaying effect of the liquid crystal panel in the operation temperature range thereof according to a third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

A deficient displaying result of a liquid crystal panel might be caused when operating in the high section of the operation temperature range thereof, and a reasonable solution thereto might be rendered through a experimental analysis of a substantial liquid crystal panel product, which is based on the model no. DM 13G10A produced by Arima Display Corp., R.O.C. The liquid crystal panel of that model comprises a conductive glass layer, an insulating layer, two alignment layers on opposite sides spaced at an interval and a liquid crystal layer disposed therebetween, wherein a ratio of the interval to the liquid crystal molecule spiral pitch of the liquid crystal layer is 0.53, and the twist angle between the two alignment layers is 240 degrees.

It is observed that the deficient displaying result like a black shadow is formed when the liquid crystal panel of that model is heated to a temperature of 40° C. by a continuous irradiation of 200 hours by a UV lamp with a magnitude of 1120 watt/m². By an investigation of a metallurgical microscope, it could be found that the deficient displaying result of a black shadow is the so-called under-domain phenomenon, and it could be inferred correspondingly that the twist angle of the liquid crystal layer fails to reach the desired twist angle between the two alignment layers, and the ratio of the interval to the liquid crystal molecule spiral pitch of the liquid crystal layer would obviously decrease.

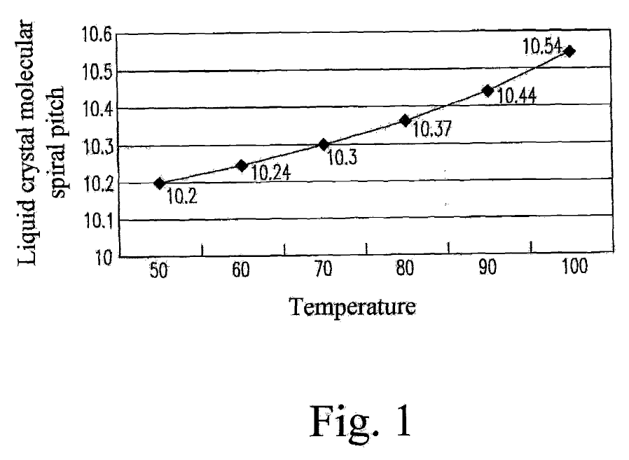

If the temperature for the liquid crystal panel is further raised, the interval between the two alignment layers would also be decreased thereby, wherein, as shown in FIG. 1, it could be obviously observed that the liquid crystal molecular spiral pitch tends to increase, so that the ratio of the interval to the liquid crystal molecular spiral pitch in the liquid crystal layer is further decreased. Accordingly, it could be inferred therefrom that the reason why the high temperature in the operation temperature range results in a deficient displaying effect as a black shadow in the liquid crystal panel is that the ratio is too low so that the twist angle of the liquid crystal layer does not comply with the desired twist angle between the two alignment layers. Accordingly, it is necessary to set up an initial ratio of the interval between the two alignment layers to the liquid crystal molecular pitch, so that the decrease or increase thereof respectively corresponding to the increase or decrease in the operation temperature does not cause the twist angle between the liquid crystal layer to be below or exceed the desired twist angle for avoiding the deficient displaying effect as the black shadow in the liquid crystal panel in the operation temperature range.

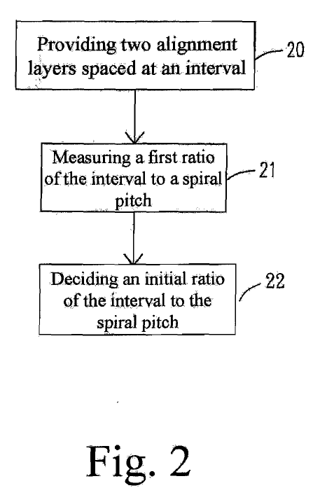

Please refer to FIG. 2, which is a diagram showing the implementing steps of the method for providing the improved displaying effect of the liquid crystal panel according to a preferred embodiment in the present invention. In the step 20, two alignment layers spaced at an interval and applied to the liquid crystal panel are provided firstly, wherein there is a desired twist angle and a liquid crystal layer disposed therebetween. In the step 21, a first ratio of the interval to the liquid crystal molecular pitch in the liquid crystal layer is measured as a maximal value, at which the twist angle of the liquid crystal layer is less than the desired twist angle between the two alignment layers. In the step 22, an initial ratio of the interval to the liquid crystal molecular pitch of the liquid crystal layer, which is varied in the operation temperature range, is decided for being rendered larger than the first ratio to provide the improved displaying effect of the liquid crystal panel in the operation temperature.

In addition, to meet the versatile requirements for the substantial liquid crystal panel, the desired twist angle between the two alignment layers could be a super twisted angle including an angle of 240 degrees, the initial ratio could be further adjusted according to one of an operation voltage parameter, a response time parameter, and a contrast parameter of the liquid crystal panel, and the architecture therefor could be designed in accordance with a mono super twisted nematic liquid crystal panel or a color super twisted nematic liquid crystal panel for the operation temperature range set from 25 to 100° C. Correspondingly, the chiral dopant influenced by the temperature to alter the liquid crystal molecular pitch, e.g. an S-811 chiral dopant, is also added to the liquid crystal layer.

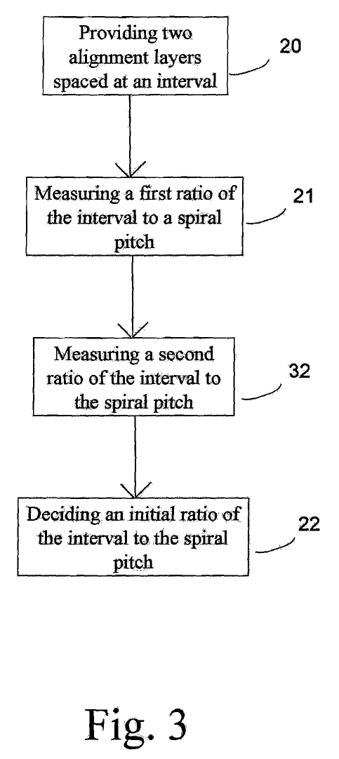

Please refer to FIG. 3, which is an implementing step diagram showing the method for providing the improved displaying effect of the liquid crystal panel according to a preferred embodiment in the present invention. In the step 20, two alignment layers spaced at an interval and applied to the liquid crystal paned are provided firstly, wherein there is a desired twist angle and a liquid crystal layer disposed therebetween. In the step 21, a first ratio of the interval to the liquid crystal molecular pitch in the liquid crystal layer is measured as a maximal value, at which the twist angle of the liquid crystal layer is less than the desired twist angle between the two alignment layers, is measured. In the step 32, a second ratio of the interval to the liquid crystal molecular pitch in the liquid crystal layer is measured as a minimal value, at which the twist angle of the liquid crystal layer is larger than the desired twist angle between the two alignment layers, is measured. Subsequently, in the step 22, an initial ratio of the interval to the liquid crystal molecular pitch of the liquid crystal layer is specified, wherein the initial ratio varied in the operation temperature range thereof keeps larger than the first ratio and less than the second ratio to provide the improved displaying effect of the liquid crystal panel.

In addition, to meet the versatile requirements for the substantial liquid crystal panel, the initial ratio could be further adjusted according to one of an operation voltage parameter, a response time parameter, and a contrast parameter of the liquid crystal panel, and the architecture therefor could be designed in accordance with a mono super twisted nematic liquid crystal panel or a color super twisted nematic liquid crystal panel for the operation temperature range set from 25 to 100° C. Correspondingly, an S-811 chiral dopant is also added to the liquid crystal layer.

To summarize, the present invention proposes a method for providing the improved displaying effect of the liquid crystal panel in the operation temperature range thereof, wherein the initial ratio of the interval between the two alignment layers to the liquid crystal molecular spiral pitch of the liquid crystal layer is specified, so that the initial ratio is varied with the operation temperature and the twist angle of the liquid crystal layer keeps consistent with the desired twist angle between the two alignment layers. Therefore, the liquid crystal layer could be reserved without replacement thereof in the present method, and the drawbacks in the prior art are thus overcome, where it is merely limited to replace the liquid crystal layer for one with a higher nematic-isotropic transition temperature to provide an improved displaying effect of the liquid crystal panel in the operation temperature range. Thus, the present invention not only bears novelty and obviously progressive nature, but also bears the utility for the industry.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar embodiments.

What is claimed is:

1. A method for providing an improved displaying effect of a liquid crystal panel, wherein the liquid crystal panel comprises two alignment layers disposing therebetween a liquid crystal layer having a spiral pitch and a liquid crystal twist angle, comprising:
(a) spacing the two alignment layers at an interval with a desired twist angle therebetween;
(b) measuring a first ratio of the interval to the spiral pitch of the liquid crystal layer, at which the liquid crystal twist angle is less than the desired twist angle between the two alignment layers; and
(C) deciding an initial ratio of the interval to the spiral pitch of the liquid crystal layer being larger than the first ratio for providing the improved displaying effect of the liquid crystal.

2. A method as claimed in claim 1, wherein the first ratio corresponds to a maximal ratio which implies that the liquid crystal twist angle of the liquid crystal layer is less than the desired twist angle between the two alignment layers.

3. A method as claimed in claim 1, further comprising a step of adjusting the initial ratio in accordance with an operation voltage parameter of the liquid crystal panel.

4. A method as claimed in claim 1, further comprising a step of adjusting the initial ratio in accordance with a response time parameter of the liquid crystal panel.

5. A method as claimed in claim 1, further comprising a step of adjusting the initial ratio in accordance with a contrast parameter of the liquid crystal panel.

6. A method as claimed in claim 1, wherein the initial ratio is varied in an operation temperature range being ranged from 25° C. to 100° C. and remains larger than the first ratio.

7. A method for providing an improved displaying effect of a liquid crystal panel in an operation temperature range thereof, wherein the liquid crystal panel comprises two alignment layers disposing therebetween a liquid crystal layer having a spiral pitch and a liquid crystal twist angle, comprising:
spacing the two alignment layers at an interval with a desired twist angle therebetween;
measuring a first ratio of the interval to the spiral pitch, wherein the first ratio implies that the liquid crystal twist angle is less than the desired twist angle between the two alignment layers; and
measuring a second ratio of the interval to the spiral pitch, wherein the second ratio implies that the liquid crystal twist angle of the liquid crystal layer is larger than the desired twist angle between the two alignment layers; and
deciding an initial ratio of the interval to the spiral pitch, wherein the initial ratio varies in the operation temperature range and maintains larger than the first ratio and less than the second ratio for providing the improved displaying effect of the liquid crystal panel in the operation temperature range.

8. A method as claimed in claim 7, wherein the first ratio corresponds to a maximal value which implies that the liquid crystal twist angle is less than the desired twist angle between the two alignment layers.

9. A method as claimed in claim 7, wherein the second ratio corresponds to a minimal value which implies that the liquid crystal twist angle of the liquid crystal layer is larger than the desired twist angle between the two alignment layers.

10. A method as claimed in claim 7, wherein the liquid crystal panel is a color super twisted nematic liquid crystal panel.

11. A method as claimed in claim 7, further comprising a step of adjusting the initial ratio in accordance with an operation voltage parameter of the liquid crystal panel.

12. A method as claimed in claim 7, further comprising a step of adjusting the initial ratio in accordance with a response time parameter of the liquid crystal panel.

13. A method as claimed in claim 7, further comprising a step of adjusting the initial ratio in accordance with a contrast parameter of the liquid crystal panel.

14. A method as claimed in claim 7, wherein the operation temperature is ranged is from 25° C. to 100° C.

15. A liquid crystal panel with an improved displaying effect in operation, comprising:
two alignment layers spaced at an interval with a desired twisted angle therebetween; and
a liquid crystal layer disposed between the two alignment layers and having a spiral pitch, a liquid crystal twist angle and an initial ratio of the interval to the spiral pitch, wherein the initial ratio is varied and maintains the liquid crystal twist angle being consistent with the desired twist angle for providing the improved displaying effect of the liquid crystal panel.

16. A liquid crystal panel as claimed in claim 15, wherein the liquid crystal panel is one of a mono super twisted nematic liquid crystal panel and a color super twisted nematic liquid crystal panel.

17. A liquid crystal panel as claimed in claim 15, wherein the operation is performed in a temperature being ranged from 25° C. to 100° C., and the initial ratio is varied in the temperature.

18. A liquid crystal panel as claimed in claim 15, wherein the liquid crystal layer includes one of an S-811 and a chiral dopant with its spiral pitch varying with a temperature.

19. A liquid crystal panel as claimed in claim 15, wherein the desired twisted angle is a super twisted angle.

20. A liquid crystal panel as claimed in claim 15, wherein the desired twisted angle is an angle of 240 degrees.
